(19) United States
(12) Patent Application Publication
(10) Pub. No.: US 2008/0309832 A1
(43) Pub. Date: Dec. 18, 2008

(54) PROJECTION DISPLAY APPARATUS AND DISPLAY METHOD APPLIED TO THE SAME

(75) Inventor: Beom-kyun RHA, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/948,562

(22) Filed: Nov. 30, 2007

(30) Foreign Application Priority Data
Jun. 13, 2007 (KR) 10-2007-0057699

(51) Int. Cl. H04N 5/74

(52) U.S. Cl. 348/771; 348/E05.137

(57) ABSTRACT

A display apparatus and a display method applied to the same are disclosed, the display apparatus including a lamp which emits a ray of light; and a panel which represents each of a plurality of pixels constituting an image in a manner such that the ray of light emitted from the lamp is reflected against a plurality of micro mirrors; wherein the plurality of micro mirrors form one square micro-mirror.

### CROSS-REFERENCE TO RELATED APPLICATIONS

This application claims priority under 35 U.S.C. §119 from Korean Patent Application No. 10-2007-0057699, filed on Jun. 13, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a display method using the same, and more particularly, to a display apparatus which displays a digital signal in a manner close to an analog signal and a display method using the same.

2. Description of the Related Art

A large-screen and high-definition display apparatus has become a very important product. In response, a wide screen display apparatus such as a projection television (TV) or a projector has been developed and commercialized.

The projection TV and projector include a common optical engine. The optical engine uses a display element such as Cathode Ray Tube (CRT), Liquid Crystal Display (LCD), or Digital Micro-mirror Device (DMD) to display signal-processed image information. Because the display element can been miniaturized and lightened, new products using the LCD or DMD rather than the heavy and thick CRT are offered.

CRTs and LCDs are driven by an analog signal, and a digital signal is converted into an analog signal in the last stage of signal processing to display signals. However, the DMD applies a pulse amplitude modulation (PAM) to a digital signal instead of employing a digital to analog (D/A) conversion to drive a signal; thus, many errors related with the D/A conversion can be avoided. Accordingly, the DMD is gaining popularity.

FIG. 1 is a view illustrating a method for operating a related art Digital Light Processing (DLP) display apparatus. Referring to FIG. 1, micro mirrors 10, 20 of a digital micro-mirror device (DMD) panel 100 receive rays of light from a lamp and drive on or off, to display black and white on a DLP display apparatus.

The micro mirrors 10, 20 reflect the rays of light received from the lamp 110 to a light absorbing unit 120 to display black, or reflect the light of light to a projection lens 130 to display white, by driving on or off at an angle approximately of ±12°. One micro mirror represents one pixel.

FIG. 2A is a view illustrating an example of a related art DMD panel structure. Referring to FIG. 2A, the DMD panel 100 having square micro mirrors 200 is illustrated. The rectangular DMD panel 100 has 2,073,600 pixels with a pixel format 1920×1080.

Since a pixel represented by the square micro mirrors 200 is in a rectangle shape, rather rough boundaries appear particularly when a curved line is represented.

FIG. 2B is a view illustrating another example of a related art DMD panel structure. Referring to FIG. 2B, the DMD panel 100 having diamond type micro mirrors 250 is illustrated. The diamond type DMD panel 100 projects an image in unit of half pixels in a vertical direction and in an alternate order using Smooth Picture technology. Accordingly, an image perceived to have resolution twice higher than the original resolution 960×1080 is provided.

Although a rough boundary of a pixel may appear softer by the above processing, image distortions appear because the image is projected in an alternate order.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a display apparatus capable of displaying details of an image and a display method applied to the same.

The present invention also provides a display apparatus which displays a digital image in a manner close to an analog image, by subdividing one micro mirror into a plurality of mirrors to represent one pixel and a display method using the same.

According to an exemplary aspect of the present invention, there is provided a display apparatus comprising a lamp which emits a ray of light, and a panel which represents each of a plurality of pixels constituting an image in a manner such that the ray of light emitted from the lamp is reflected against a plurality of micro mirrors.

The plurality of micro mirrors may be triangle micro mirrors.

The plurality of triangle micro mirrors may be generated by dividing one square micro mirror into four parts.

The plurality of micro mirrors may form one square micro mirror.

The one square micro mirror may display the one pixel.

The apparatus may further comprise a data processing unit which analyzes pixels of image data, and converts the image data corresponding to each of the plurality of pixels into a plurality of sequence data such that one pixel is displayed by the plurality of micro mirrors, and a panel driving control unit which generates a driving-control signal to control position of the plurality of micro mirrors constituting the panel, on the basis of sequence data converted by the data processing unit.

The panel may control the position of the plurality of micro mirrors according to the driving-control signal corresponding to each of the plurality of micro mirrors, so that the ray of light emitted from the lamp is reflected to display one pixel.

According to another exemplary aspect of the present invention, there is provided a display method comprising emitting a ray of light, and representing each of a plurality of pixels constituting an image in a manner such that the ray of light emitted light is reflected against a plurality of micro mirrors.

The plurality of micro mirrors may be triangle micro mirror.

The plurality of micro mirrors may be generated by dividing one square micro mirror into four parts.

The plurality of micro mirrors may form one square micro mirror.

The one square micro mirror may display the one pixel.

The method may further comprise analyzing pixels of image data, and converting the image data corresponding to each of the plurality of pixels into a plurality of sequence data such that one pixel is displayed by the plurality of micro mirrors, and generating a driving-control signal to control position of the plurality of micro mirrors constituting the panel, on the basis of sequence data converted by the data processing unit.

The displaying may control the position of the plurality of micro mirrors according to the driving-control signal corresponding to each of the plurality of micro mirrors, so that the ray of light emitted from the lamp is reflected to display one pixel.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating a method for operating a related art Digital Light Processing (DLP) display apparatus;

FIG. 2A is a view illustrating an example of a related art digital micro-mirror device (DMD) panel structure;

FIG. 2B is a view illustrating another example of a related art DMD panel structure;

FIG. 3 is a view illustrating a DMD panel structure according to an exemplary embodiment of the present invention;

FIG. 4 is view illustrating a method for driving DMD panel according to an exemplary embodiment of the present invention;

FIG. 5 is a block diagram of a display apparatus according to an exemplary embodiment of the present invention;

FIG. 6 is a flowchart illustrating a display method of a display apparatus according to an exemplary embodiment of the present invention; and

FIG. 7 is a view illustrating an image displayed in accordance with a display method of a display apparatus according to an exemplary embodiment of the present invention.

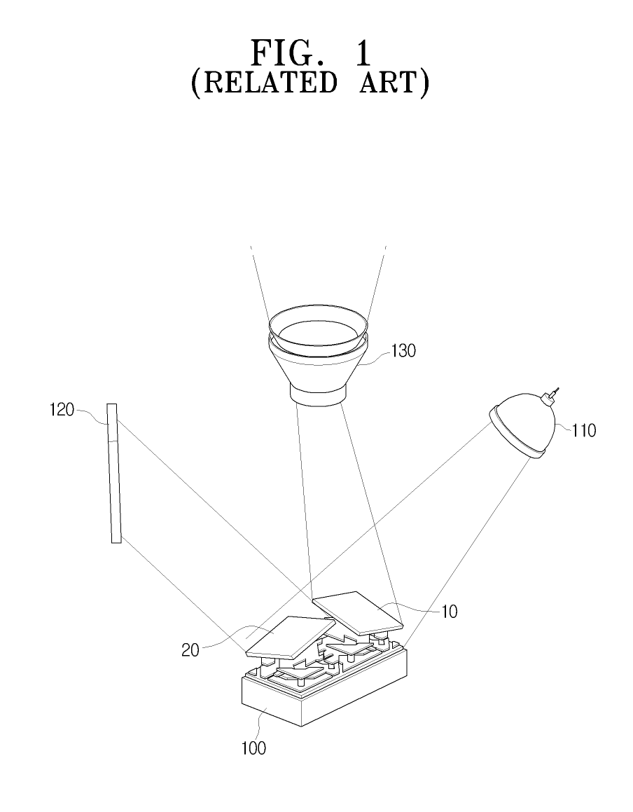

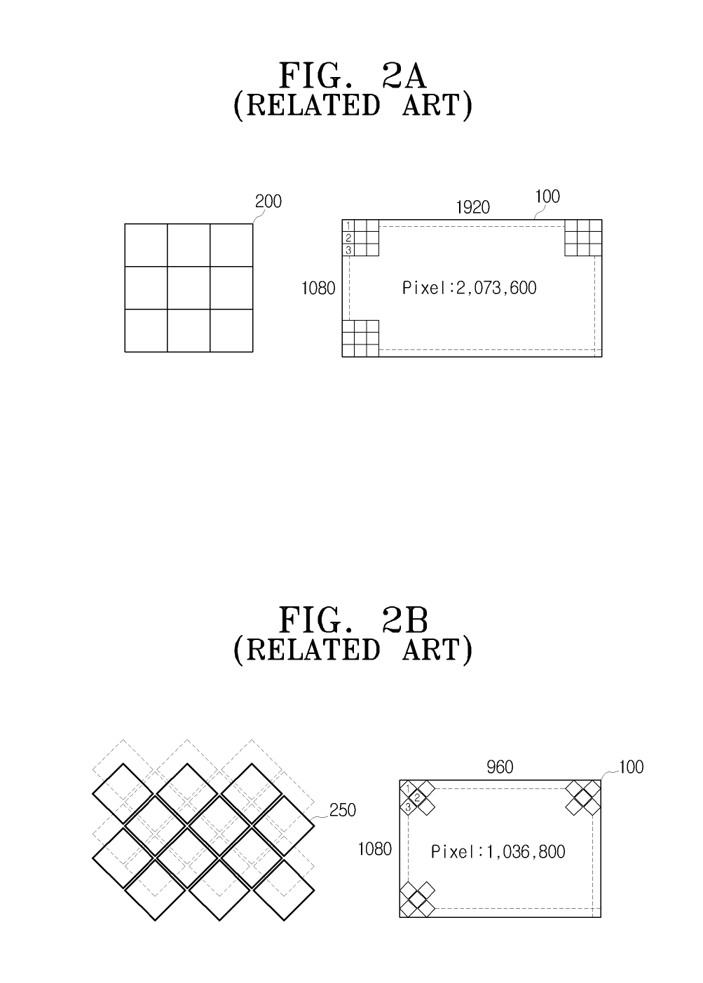

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

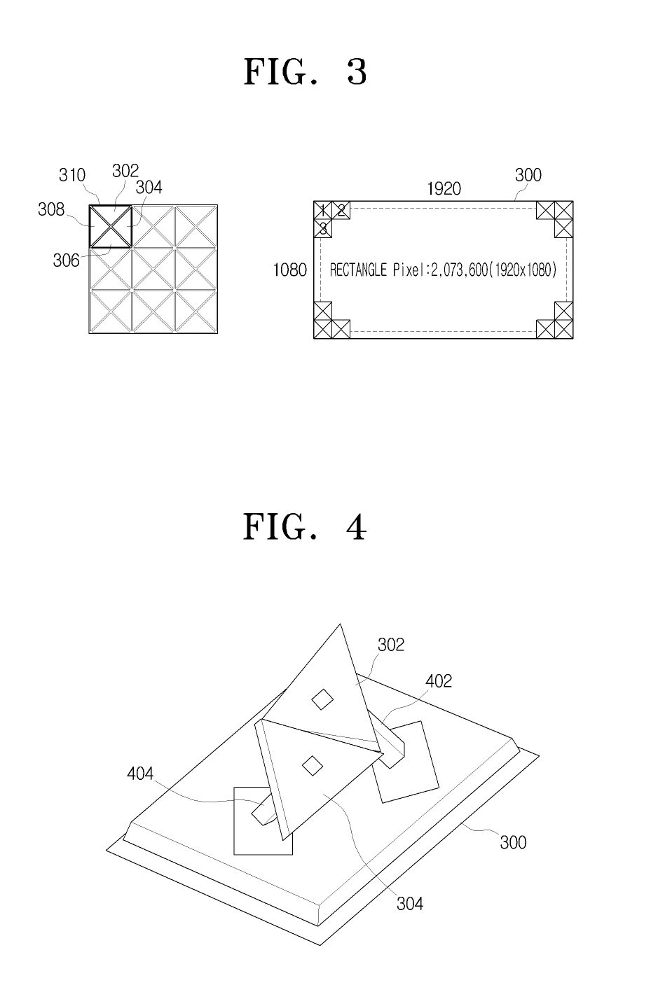

FIG. 3 is a view illustrating a DMD panel structure according to an exemplary embodiment of the present invention.

Referring to FIG. 3, a DMD panel 300 includes a plurality of square micro mirrors 310. Each of the square micro mirrors 310 is divided into four triangle micro mirrors 302, 304, 306, 308.

One micro mirror 310 represents one pixel. That is, one pixel is displayed by a combination of the four triangle micro mirrors 302, 304, 306, 308.

Because one square micro mirror 310 corresponds to one pixel, the DMD panel 300 has the same number of pixels as the DMD panel 100 of the related art rectangle micro mirrors 200 at the same resolution. For example, if a resolution of an image is 1920×1080, the number of pixels is same as 2,073,600 pixels.

FIG. 4 is a view illustrating a method for driving a DMD panel according to an exemplary embodiment of the present invention.

Referring to FIG. 4, the first and second driving elements 402, 404 are disposed at a lower part of each of the first and second triangle micro mirrors 302, 304 to control position of the first and second triangle micro mirrors 302, 304.

The first and second triangle micro mirrors 302, 304 are controlled by the first and second driving elements 402, 404, independently. The first triangle micro mirror 302 is controlled by the first driving element 402, the second triangle micro mirror 304 is controlled by the second driving element 404, the third triangle micro mirror 306 is controlled by the third driving element 406, and the fourth triangle micro mirror 308 is controlled by the fourth driving element 408, to display one pixel.

The four micro mirrors 302, 304, 306, 308 are driven on or off at an angle of about ±12° by control of the four driving elements 402, 404, 406, 408, to reflect light to display one pixel.

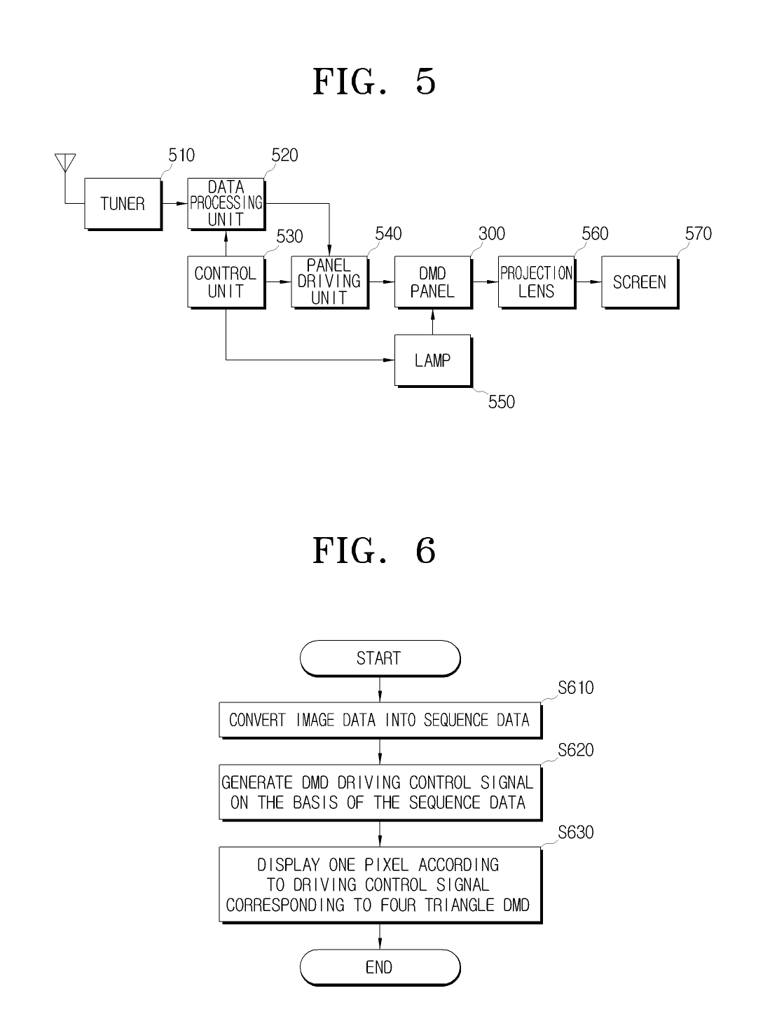

FIG. 5 is a block diagram of a display apparatus according to an exemplary embodiment of the present invention.

Referring to FIG. 5, a display apparatus having the DMD panel 300 may comprise a tuner 510, a data processing unit 520, a control unit 530, a panel driving unit 540, a lamp 550, a projection lens 560, and a screen 570.

The data processing unit 520 converts image data of an image signal being received through the tuner 510 by the control unit 530 into sequence data to drive the DMD panel 300, and outputs the converted sequence data.

The data processing unit 520 analyzes each pixel of the image data, and outputs sequence data. More specifically, the data processing unit 520 analyzes each pixel, and converts image data corresponding to each pixel into four sequences so as to represent one pixel with four triangles.

The panel driving unit 540 generates and outputs a driving signal to control position of the micro mirrors of the DMD panel 300 on the basis of the sequence data output from the data processing unit 520.

The panel driving unit 540 generates four driving-control signals to control the position of the four micro mirrors on the basis of the four sequence data corresponding to one pixel.

The lamp 550 emits a ray of white light on the DMD panel 300 by the control unit 530.

The driving elements of the DMD panel 300 control the position of the corresponding micro mirrors according to the driving-control signal output from the panel driving unit 540, so as to cause the ray of white light emitted from the lamp 500 to be reflected.

The projection lens 560 outputs the light reflected from the DMD panel 300 onto the screen 570 so that the light is displayed in the size fitting the screen 570.

FIG. 6 is a flowchart illustrating a display method of a display apparatus according to an exemplary embodiment of the present invention.

Referring to FIG. 6, the data processing unit 520 analyzes respective pixels, converts image data into sequence data to drive the DMD panel 300, and outputs the converted sequence data (S610).

The panel driving unit 540 generates and outputs a driving signal to control position of the micro mirrors constituting the DMD panel 300 on the basis of the sequence data output from the data processing unit 520 (S620).

The DMD panel 300 controls position of each of the micro mirrors according to a driving control signal of driving elements corresponding to four triangle micro mirrors, and reflects a ray of white light emitted from the lamp 500 to display one pixel (S630).

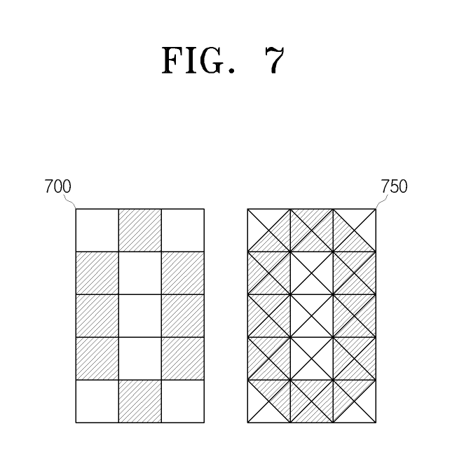

FIG. 7 is a view illustrating an image displayed in accordance with a display method of a display apparatus according to an exemplary embodiment of the present invention.

FIG. 7 illustrates a number ‘0’ (700) displayed on the related art DMD panel 100 wherein one pixel is represented using square micro mirror, and a number ‘0’ (750) displayed on the DMD panel 300 according to an exemplary embodiment of the present invention wherein one pixel is represented using four triangle micro mirrors.

A curved line is rough in an image when each pixel is represented by one square micro mirror.

On the other hand, a curved line is soft, and represented in a more accurate configuration when each pixel is represented by the four triangle micro mirrors.

As described above, despite the use of digital element, an image is displayed in a manner close to an analog.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A display apparatus comprising:
a lamp which emits a ray of light; and
a panel which represents a plurality of pixels constituting an image;
wherein each of the plurality of pixels is formed in a manner such that the ray of light emitted from the lamp is reflected against a plurality of micro mirrors.

2. The apparatus of claim 1, wherein the plurality of micro mirrors are triangle micro mirrors.

3. The apparatus of claim 2, wherein the plurality of triangle micro mirrors are generated by dividing the one square micro mirror into four parts.

4. The apparatus of claim 1, wherein the plurality of micro mirrors form one square micro mirror.

5. The apparatus of claim 3, wherein the one square micro mirror displays the one pixel.

6. The apparatus of claim 1, wherein each of the plurality of micro mirrors are individually driven.

7. The apparatus of claim 5, wherein each of the plurality of micro mirrors are driven at an angle of approximately ±12°.

8. The apparatus of claim 1, further comprising:
a data processing unit which analyzes pixels of image data, and converts the image data corresponding to each of the pixels into a plurality of sequence data such that one pixel is displayed by the plurality of micro mirrors; and
a panel driving control unit which generates a driving-control signal to control position of the plurality of micro mirrors constituting the panel, on the basis of sequence data converted by the data processing unit.

9. The apparatus of claim 8, wherein the panel controls the position of the plurality of micro mirrors according to the driving-control signal corresponding to each of the plurality of micro mirrors, so that the ray of light emitted from the lamp is reflected to display one pixel.

10. A display method comprising:
emitting a ray of light; and
representing each of a plurality of pixels constituting an image,
wherein each of the plurality of pixels is formed in a manner such that the ray of light emitted light is reflected against a plurality of micro mirrors.

11. The method of claim 10, wherein the plurality of micro mirrors are triangle micro mirrors.

12. The method of claim 11, wherein the plurality of micro mirrors are generated by dividing one square micro mirror into four parts.

13. The method of claim 10, wherein the plurality of micro mirrors form one square micro mirror.

14. The method of claim 12, wherein the one square micro mirror displays the one pixel.

15. The method of claim 10, further comprising:
analyzing pixels of image data, and converting the image data corresponding to each of the pixel into a plurality of sequence data such that one pixel is displayed by the plurality of micro mirrors; and
generating a driving-control signal to control position of the plurality of micro mirrors constituting the panel, on the basis of sequence data converted by the data processing unit.

16. The method of claim 15, further comprising driving each of the plurality of micro mirrors individually in accordance with the generated driving control signal.

17. The apparatus of claim 16, wherein each of the plurality of micro mirrors are driven at an angle of approximately ±12°.

18. The method of claim 15, wherein the displaying controls the position of the plurality of micro mirrors according to the driving-control signal corresponding to each of the plurality of micro mirrors, so that the ray of light emitted from the lamp is reflected to display one pixel.
